(19) United States
(12) Patent Application Publication
(10) Pub. No.: US 2004/0008335 A1
(43) Pub. Date: Jan. 15, 2004

(54) Novel method and apparatus for flow monitoring in mirco-fluidic devices

(76) Inventors: Mark Hayes, Tempe, AZ (US); Joseph St. Claire, Redding, CA (US)

Correspondence Address: Pitney Hardin Kipp & Szuch, 685 Third Avenue, New York, NY, 10017, US

(21) Appl. No.: 10/296,431

(22) PCT Filed: May 23, 2001
(86) PCT No.: PCT/US01/16765

(51) Int. Cl. G01P 3/36

(52) U.S. Cl. 356/28.5

(57) ABSTRACT

The present invention relates to a process for monitoring the flow rate of a fluid stream which comprises heating the stream with a heating member for a time sufficient to induce a change in the refractive index of the fluid; detecting the change in the refractive index of the fluid at a location remote from the heating member; and calculating the flow rate of the fluid from the change in the refractive index.

### FIELD OF THE INVENTION

This invention relates to microchip devices, capillary electrophoresis, or any technique or process that uses small bore fluid-filled channels or tubes where monitoring of the fluid flow is of interest. More particularly, this invention is directed to a novel on-line, non-invasive, and real-time method for monitoring fluid-flow in a tube or passageway in which fluid is heated causing a change in refactive index and the change in refractive index is used to monitor flow rate.

### BACKGROUND OF THE INVENTION

The monitoring of flow in small volumes is important for many analytical techniques and will become especially important as analytical devices are miniaturized and integrated onto microchips. Analytical techniques include on-line derivatization, flow injection analysis, and many other separation science techniques, including high-pressure liquid chromatography, capillary zone electrophoresis, and capillary electrokinetic chromatography. Presently, no simple non-invasive methods exist to monitor flow rate or direction in the nanoliter to picoliter volumes. Just as it is difficult or impossible to control microelectronic components without voltage and current measurements, it is problematic to accurately control fluids on micro-instruments and small volume analytical techniques without flow monitoring and control. Similarly, just as electrons are moved and monitored in electronics, fluids will be moved and monitored in fluidic microdevices. However, in contrast to the field of microelectronics, an analogous control and monitoring method for fluid movement in microdevices does not exist.

Fluid flow can be generated by pressure, electroosmosis, or by any other suitable method. Regardless of how fluid movements are generated, such movements cannot be effectively controlled without monitoring to provide feedback. This shortcoming may significantly impede the development of truly complex miniaturized instrumentation and the optimized operation of microanalytical techniques.

There are several methods known in the art for determining the rate at which a fluid travels through a small bore tube. The most common method involves using an innocuous chemical marker with some easily detectable property, such as UV absorbance. This method is described in the following three articles, all of which are incorporated by reference: (1) Lauer, H. H.; McGanigill, D. “Capillary Zone Electrophoresis of Proteins in Untreated Fused Silica Tubing” Anal. Chem. 1986, 58, 166-170; (2) Lukacs, K. D.; Jorgenson, J. W. “Capillary Zone Electrophoresis: Effect of Physical Parameters on Separation Efficiency and Quantitation” J. High. Res. Chrom. & Chrom. Comm. 1985, 8, 407-411; and (3) Stevens, T. S.; Cortes, H. J. “Electroosmotic Propulsion of Eluent through Silica Based Chromatographic Media” Anal. Chem. 1983, 55, 1365-1370. With this technique, an appropriate species is introduced into the flow stream and detected a known distance downstream. By monitoring the elapsed time, the flow rate of the fluid is calculated. However, this technique does not provide non-invasive monitoring since a bolus of foreign material must be introduced into the flow stream, creating an adulterated sample and injection mechanism complexities.

Another method involves weighing a mass of fluid that elutes from the tube in a known amount of time. This method requires calibration of each fluid system. Also, this offline method necessitates a highly accurate mass balance and exact measurement of the capillary internal diameter or geometric dimensions. This method is described in the following three references, all of which are incorporated by reference: (4) van de Goor, A. A. A. M.; Wanders, B. J.; Everaerts, F. M. “Modified Methods for Off- and On-Line Determination of Electroosmosis in Capillary Electrophoretic Separations” J. Chromatogr. 1989, 470, 95-104; (5) Altria, K. D.; Simpson, C. F. “Measurement of Electroendosmotic Flows in High-Voltage Zone Electrophoresis” Anal. Proc. 1986, 23, 453-454; and (6) Altria, K. D.; Simpson, C. F. “High Voltage Capillary Zone Electrophoresis; Operating Parameters Effects on Electroendosmotic Flows and Electrophoretic Mobilities” Chromatographia 1987, 24, 527-532.

For capillary electrophoresis applications, monitoring the current when a buffer of differing concentration is introduced into the injection end of the capillary has been used to monitor flow. This method is described in the following three references, all of which are incorporated by reference: (7) Lee, C. S.; Blanchard, W. C.; Wu, C. T. “Direct Control of the Electroosmosis in Capillary Electrophoresis by Using an External Electric Field” Anal. Chem. 1990, 62, 1550-1552; (8) Huang, X; Gordon, M.; Zare, R. N. “Current-Monitoring Method for Measuring the Electroosmotic Flow Rate in Capillary Zone Electrophoresis” Anal. Chem. 1988, 60, 1837-1838; and (9) Tsuda, T. “Electroosmotic Flow and Electric Current in Capillary Electrophoresis” J. Liq. Chrom. 1989, 12, 2501-2514. Under such conditions, the total conductivity across the capillary is proportional to a weighted average of the conductivity of each buffer solution. This system does not provide real-time monitoring of fluid flow because the determination of the fluid flow rate requires that the buffer migrate the entire length of the capillary before such a determination is made. Furthermore, this system is not non-invasive because the buffer concentration in the fluid is altered.

Two real-time methods known in the art involve monitoring the flow immediately outside a flow tube. The first technique involves placing a conductivity measuring device at the detection end of the capillary. This technique is based on the ionic strength of the buffer reservoir changing with the delivery of a more concentrated buffer from within the capillary. This method is described in the following reference, all of which is incorporated by reference: (10) Wanders, B. J.; Van de Goor, A. A. A. M.; Everaerts, F. M. “On-line Measurement of Electroosmosis in Capillary Electrophoresis Using a Conductivity Cell” J. Chromatogr. 1993, 652, 291-294. The second technique is a laser induced fluorescence post-column reaction scheme in which the fluorescent signal is proportional to the flow. Neither of these techniques are on-line, nor non-invasive, and neither technique can be applied in complex systems. This method is described in the following reference, all of which is incorporated by reference: Lee, T. T.; Dadoo, R.; Zare, R. N. “Real-time Measurement of Electroosmotic Flow in Capillary Zone Electrophoresis” Anal. Chem. 1994, 66, 2694-2700.

A variety of cross-beam optical techniques have been developed to non-invasively determine flow rates. These methods are described in the following three references, all of which are incorporated by reference: (12) Rose, A.; Vyas, R.; Gupta, R. “Pulsed Photothermal Deflection Spectroscopy in a Flowing Medium: A Quantitative Investigation” App. Optics 1986, 25, 4626-4643; (13) Sontag, H.; Tam, A. C. “Time-Resolved Flow-Velocity and Concentration Measurements Using a Traveling Thermal Lens” Opt. Let. 1985, 10, 436-438; and (14) Weimer, W. A.; Dovichi, N. J. “Time-Resolved Crossed-Beam Thermal Lens Measurement As a Nonintrusive Probe of Flow Velocity” App. Optics 1985, 24, 2981-2986. Several of these techniques require particulate matter because they utilize the Doppler effect, or can only be applied to gases and are therefore not useful with respect to monitoring flow of liquids. All of these cross-beam optical techniques suffer from high accuracy alignment requirements and high power output signals. Thus, these techniques are not particularly useful and have not found application outside the academic laboratory.

In view of the above, there is a need for a system based on rugged, standard, and inexpensive equipment to accurately monitor flow in a small diameter capillary. In addition, there is a need for a system which is not susceptible to vibrations, as is typical in systems requiring precise optical alignment, and which can be utilized in miniaturized systems. It is, therefore, an object of the present invention to introduce a novel on-line, non-invasive, and real-time method for monitoring fluid-flow in a tube or passageway.

### SUMMARY OF THE INVENTION

The present invention provides a process for monitoring in real time the flow rate of a microfluidic stream which involves heating the stream for a predetermined amount of time to induce a change in the refractive index of the fluid, monitoring the change in the refractive index of the fluid at a location remote from where the heating takes place, calculating the flow rate from the change in the refractive index, and repeating these steps as necessary.

An apparatus for monitoring the flow rate of a microfluidic stream is also provided, wherein the apparatus has a capillary or channel tube having inlet and outlet ends and adapted thereto a heating member for heating the microfluidic stream for a predetermined amount of time, refractive index detector positioned away from the capillary or channel tube to measure the refractive index of the fluid stream at a location remote from the heating member; and a data gathering and analysis system connected to the refractive index detector for calculating the flow rate from the change in the refractive index of the fluid stream.

### BRIEF DESCRIPTION OF THE DRAWINGS

Further objects and advantages of the present invention will be more fully appreciated from a reading of the detailed description when considered with the accompanying drawings wherein:

FIG. 1 is a schematic drawing of a fluid flow-monitoring arrangement in accordance with the invention;

FIG. 2 is a schematic of an embodiment of the heating/detection component of a flow monitoring system in accordance with the invention;

FIG. 3. is a graph laser interferometric backscatter response to a bolus of altered refractive index solution in a flowing stream with the calculated first and second derivatives of the detector response superimposed therein;

FIG. 4 is a graph laser interferometric backscatter response versus temperature for a fluid in a fluid flow-monitoring arrangement according to the invention;

FIG. 5. is a graph laser interferometric backscatter response versus the refractive index for fluid in a fluid flow-monitoring arrangement according to the invention;

FIG. 6. is a graph of the flow rate generated by various pressures measured by weighing the fluid upon exiting the capillary tube.

FIG. 7. is a graph showing an embodiment of the calculated flow rate as measured by the refractive index patterning/laser interferometric backscatter flow monitoring system.

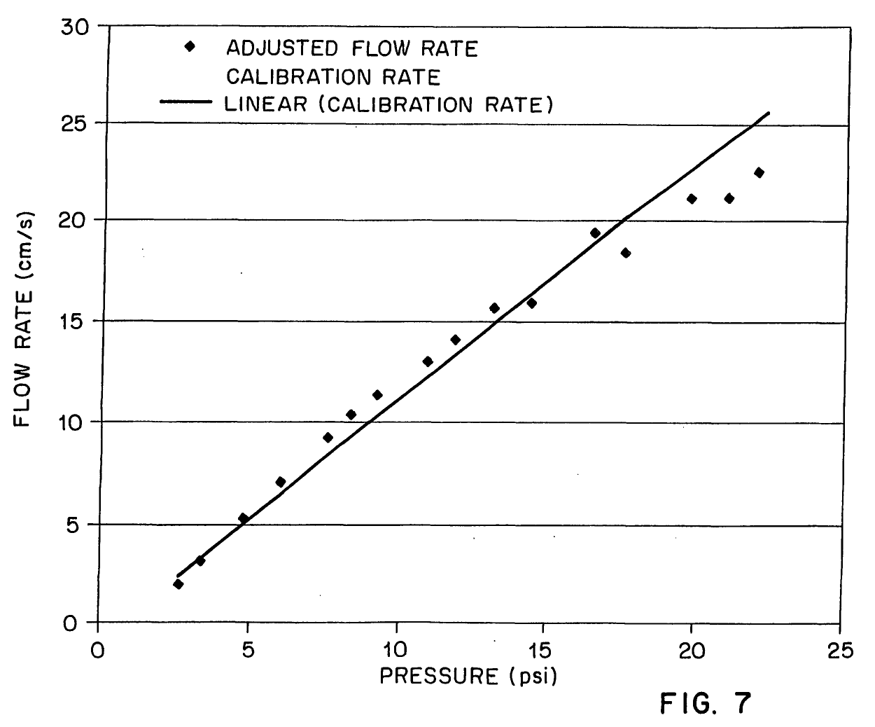

### DETAILED DESCRIPTION OF THE PREFERRED EMBODIMENTS

The present invention provides a process for monitoring small volume flows by the altering the refractive index (RI) of a microfluidic flow stream and monitoring that altered RI of the fluid stream at a location remote thereto. Through knowledge of the time of the alteration, the distance to the monitoring device, and the time at which the fluid having the altered refractive index (RI) is detected, the flow rate of the fluid can be calculated.

In accordance with the present invention, the fluid flows through a capillary or channel tube having inlet and outlet ends, a refractive index detector, and a data gathering and analysis system. A heating member adapted to the capillary or channel tube heats the microfluidic stream for a predetermined amount of time. Any suitable heating method can be used. Heating the fluid induces a change in the RI of the fluid. The heating member can be a resistive element where heating takes place through conduction across the capillary or channel tube wall, or an apparatus which is a source of some type of radiation which heats the fluid, such as an infra-red or microwave radiation source. In one embodiment pulses of radiation are applied to the flow stream at a single location. This causes the fluid flowing in the tube or capillary to exhibit an alternating refractive index pattern, or thermal encoding of the fluid.

A refractive index detector is positioned from the capillary or channel tube to measure the refractive index of the fluid stream at a location downstream from the heating element. The RI change is monitored by any technique known in the art. In one embodiment, the refractive index is monitored by laser interferometric backscatter (LIB), a new technology with a simple optical train, minimal alignment requirements, and excellent sensitivity. The LIB system can be extensively modified to shorten the optical path and optimize the sensitivity to work in extremely small environments.

LIB technology is described in the following references, all of which are incorporated by reference in their entireties: (15) Tarigan, H. J.; Neill, P.; Kenmore, C. K.; Bornhop, D. J. “Capillary-Scale Refractive Index Detection by Interferometric Backscatter” Anal. Chem. 1996, 68, 1762-1770; (16) Bornhop, D. J. “Microvolume Index of Refraction Determinations by Interferometric Backscatter” Appl. Opt. 1995, 34, 3234-3239; and (17) Bornhop, D. J. “Laser-based Refractive Index Detector Using Backscatter” U.S. Pat. No. 5,325,170 1993. LIB can operate in small diameter capillaries, which will enable extremely small volume flows to be monitored accurately and easily.

A data gathering and analysis system is connected to the refractive index detector to calculate the flow rate from the change in the refractive index of the fluid stream.

In a preferred embodiment, the apparatus includes a heating element; a channel or capillary; a method to induce flow, such as pressure or electroosmosis; an interferometric backscatter device comprising a laser, a slit assembly, a CdS light sensor, and positioning equipment; and a data gathering and analysis system. In another embodiment, the direct measurement of small volume flows provides feedback for flow control systems. The flow measurement information can be fed back into the flow control system to maintain a stable or constant flow, and to stop flow in a dynamic, real time manner.

The apparatus of the present invention can be used with a variety of small volume techniques which utilize fluid flow and where fluid flow must be monitored and controlled. These techniques include, but are not limited to, capillary electrophoresis; related electrokinetic separation techniques, including capillary electrochromatography; flow injection analysis; and microprobe liquid chromatography. Apparatus of this invention is ideally suited for application on fluidic microchip devices where the movement of fluids is the fundamental process. Fluids, especially in this application, must be monitored and controlled on a noninvasive basis because the materials must remain unaltered for further processing or analysis.

This invention provides a simple and non-invasive method for monitoring flow without significant cost or technical complexity. The heating element and the LIB can be reduced in size and cost, where they can be collapsed down in size to the point of a plug-in module which could be placed into any microchip device or as an add-on for general application on existing instrumentation.

In another embodiment, the present invention includes a capillary or channel tube having a length, a cross section, an inlet end, and an outlet end. The ends are in fluid-flow connection with a reservoir, or they may be interconnected with another channel or capillary. A heat source which provides a temporal pattern of heating is present within the length of the tube. Also present in close proximity to the heat source is a LIB detection system in connection with a data acquisition and manipulation system. The information from the heat source and the data system is used to directly measure the flow velocity and that information can be used directly to control the flow. The electronics to operate the heat source, the LIB, the data system, and the flow control can all be integral to the device, external to the device, or even integrated into hybrid fluidic/electronic microdevices.

In another embodiment of the invention, a flow monitoring device combines two LIB detectors in series along the capillary or tube with a heating zone to one side. This design will remove the heating lag time and will prevent the effects from the heat loss to the walls from influencing the measured flow rate. With this design, the distance between the two detection zones is known, so that the time that it takes a heated zone to travel between the two detectors is a direct measure of flow rate.

### EXAMPLE 1

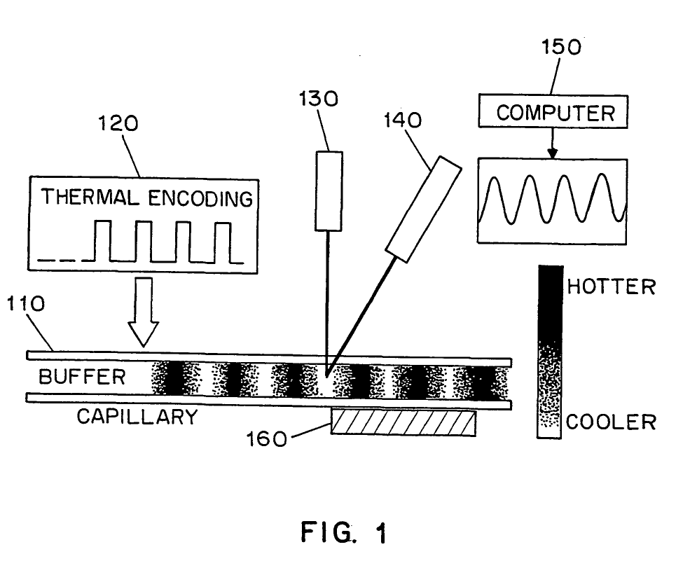

A flow monitoring system utilizing temporal heating in accordance with the invention is shown in FIG. 1. Fused silica capillary tubing, such as the tubing produced by Polymicro Technologies of Phoenix, Ariz., which has about a 349 micron outer diameter by about a 184 micron inner diameter, and which is about 71 cm in length, is used in the capillary 110. Flow through the capillary 110 is controlled by a pressure regulator (not shown) which maintains the pressure at about 0 to about 25 psi. A device capable of thermal encoding 120, where the encoding may be performed by any method known in the art, encodes the fluid in the capillary. The change in the RI is monitored by laser interferometric backscatter. A laser 130 is used to reflect a laser beam off the capillary tube and into a camera, such as a CCD Camera 140. The backscattered light from the capillary tube passes through an optical slit, which may be about 75 microns wide, such as the optical slit manufactured by Edmund Scientific, Barrington, N. J. The backscattered light then passes into a CdS photo dependent resistor (PDR) detector assembly. The PDR assembly consists of a PDR assembly in series with a kilo-ohm resistor. The voltage across the resistor is measured by an A/D converter (not shown) controlled by a computer 150, which runs signal analysis software, such as Labview software. A thermostatic block 160 attached to the capillary keeps the temperature of the system static except for that induced by purposeful heating.

### EXAMPLE 2

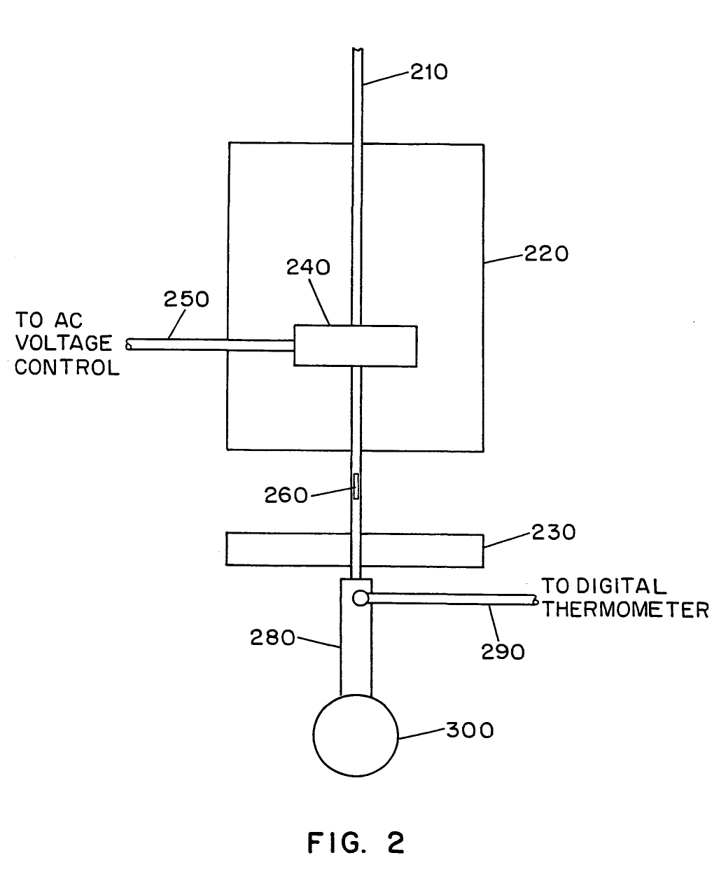

An alternative arrangement utilizing a resistive element in accordance with the invention is shown in FIG. 2. A capillary 210 is held in place with a stabilizing platform 220 on the upstream side of the detector and an outlet bracket 230 on the downstream side. For calibration experiments, the effluent from the capillary is collected for a set period of time and weighed to determine the average volume flow rate.

A coiled piece of wire, such as a 620 micron diameter wire made of nickel and chromium which is 5 cm in length, is embedded into the stabilizing platform 220. The wire is coiled into a heating coil 240 so that it circles the capillary 210 three times with a minimum of air space between the coil and the tubing. The wire is attached to a variable current controller 250, which may be an AC Voltage Control. The capillary 210 passes through the beam of a laser, such as a 5 milliwatt HeNe laser at a location in close proximity to the heating coil, and then into the capillary outlet bracket 230. A detector window 260, which may be 1 cm wide, is formed on the tubing by burning away the polyamide coating and removing the char. The beam of the laser is aimed at the detector window 260. A piece of plastic tubing 270, such as a 3 cm piece of 360 micron internal diameter plastic tubing, is attached to the outlet bracket 230. A thermocouple 280 is embedded into the plastic tubing 270 so that it makes contact with the fluid. The plastic tubing is sealed with any substance known in the art, such as epoxy. The signal from the thermocouple is sent to a digital thermometer 290 and is used to measure the temperature of the fluid in the capillary. The fluid from the capillary then passes into an outlet reservoir 300.

### EXAMPLE 3

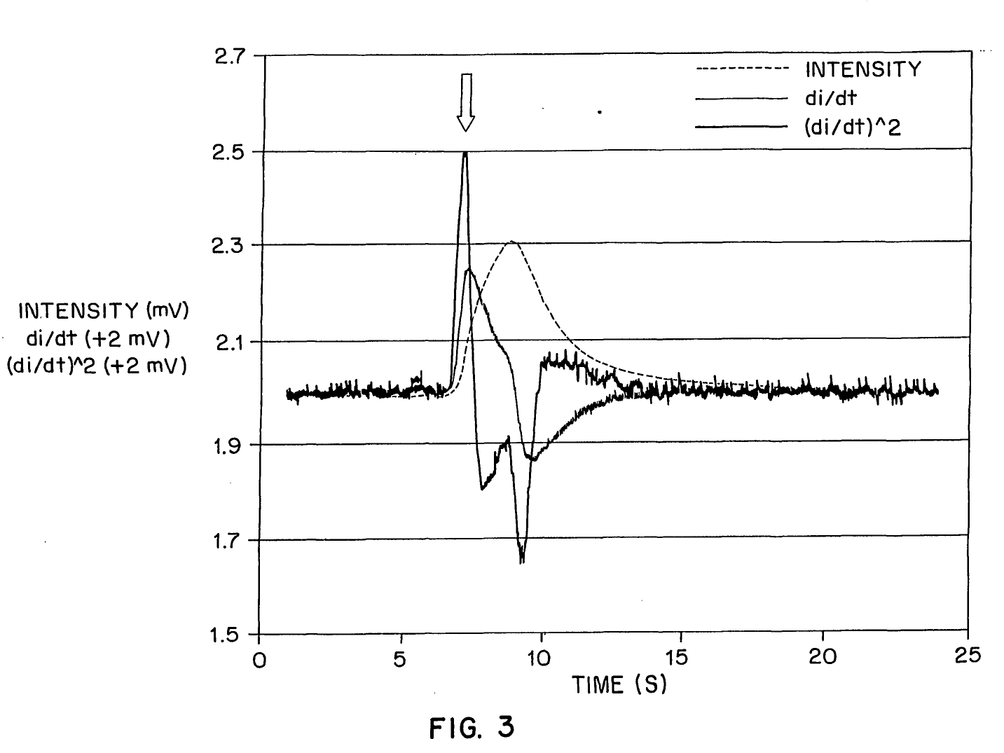

To introduce a heat plug into the fluid, current was passed through a heating coil wrapped around a tube capillary for two seconds. The backscattered light intensity from the tube a short distance from the coil, about 1.2 cm, was recorded for about 25 seconds. The temperature change caused by this heating is about a few hundred millidegrees, and this temperature change is sufficient to allow measurement of the arrival time of the heat plug to the LIB. To aid accuracy and automation in determining arrival time, the first and second derivatives of the LIB signal were also calculated, as shown in FIG. 3. Data was collected at various flow rates generated by pressure, ranging from about 2 to about 25 psi, and the measured flow rate was plotted. To equate the actual flow to that measured by this device, a correction factor must be used. This conversion was necessitated due to errors caused by time lags in conductive heating of the fluid and heat loss to the walls in the first fluid elements being transported through the tube between the heating zone and the detection zone. The time lags in conductive heating of the fluid and the heat loss to the walls are systematic and reproducible physical processes and thus do not pose significant problems for the operation of the device. Furthermore, both the heating lag time and heat loss can be minimized in a more refined experimental apparatus. To perform this conversion, the calculated heat plug velocity, vₕ, measured in units of cm/s, is converted to the actual velocity, v, also measured in cm/s, as measured by calibration experiments, by the following formula:

v=0.1 exp(3.6vₕ).

### EXAMPLE 4

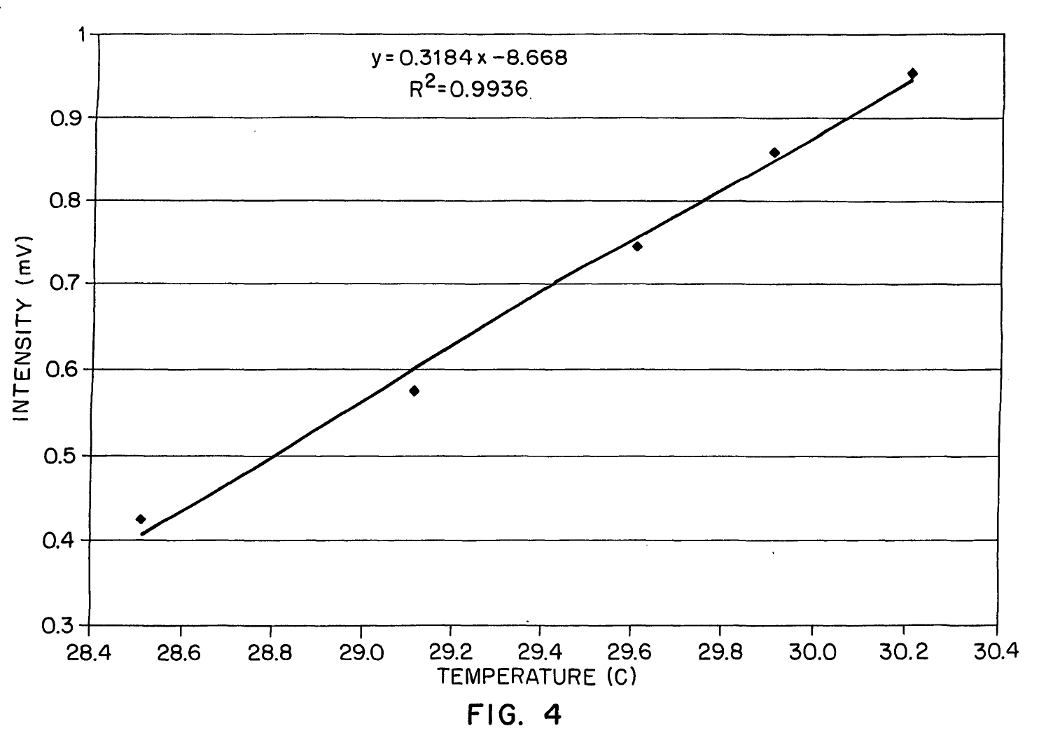

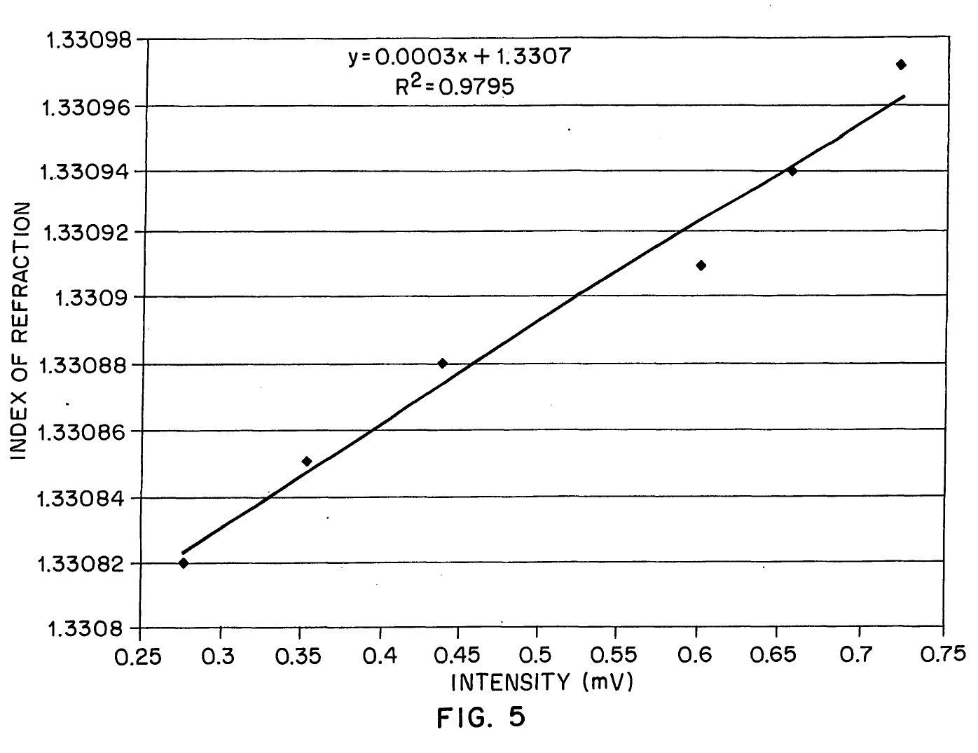

To characterize the flow monitoring system, the RI was altered by both heat and fluid composition. To determine correlation of RI temperature, the diffraction pattern of fluid in a capillary was measured at fluid temperatures ranging from about 28 to about 30 degrees centigrade. A constant current was applied to a heating coil wrapped around the capillary and the system was allowed to reach steady state, which takes about 5 minutes. The output from the PDR assembly was collected from the PDR assembly at about 250 Hz for about 12 seconds and was stored in a spreadsheet program. The temperature of the fluid was recorded. Data was averaged and the result was plotted against temperature, as shown in FIG. 4. The relationship is linear over about 1.5 degrees and the statistical spread is insignificant over this range, which is consistent with published results, as reported in the following article: Tarigan, H. J.; Neill, P.; Kenmore, C. K.; Bornhop, D. J. “Capillary-Scale Refractive Index Detection by Interferometric Backscatter” Anal. Chem. 1996, 68, 1762-1770. To further characterize the system, direct alteration of the fluid was accomplished by changing the composition of the fluid, as shown in FIG. 5. A series of methanol/water solutions ranging from about 0% to about 9% was introduced into the capillary and the resulting LIB signals were recorded. The RI varied by about 1.5×10⁻⁴ RI units These results are consistent with prior work with the LIB, as described in the following article: Tarigan, H. J.; Neill, P.; Kenmore, C. K.; Bornhop, D. J. “Capillary-Scale Refractive Index Detection by Interferometric Backscatter” Anal. Chem. 1996, 68,1762-1770.

### EXAMPLE 5

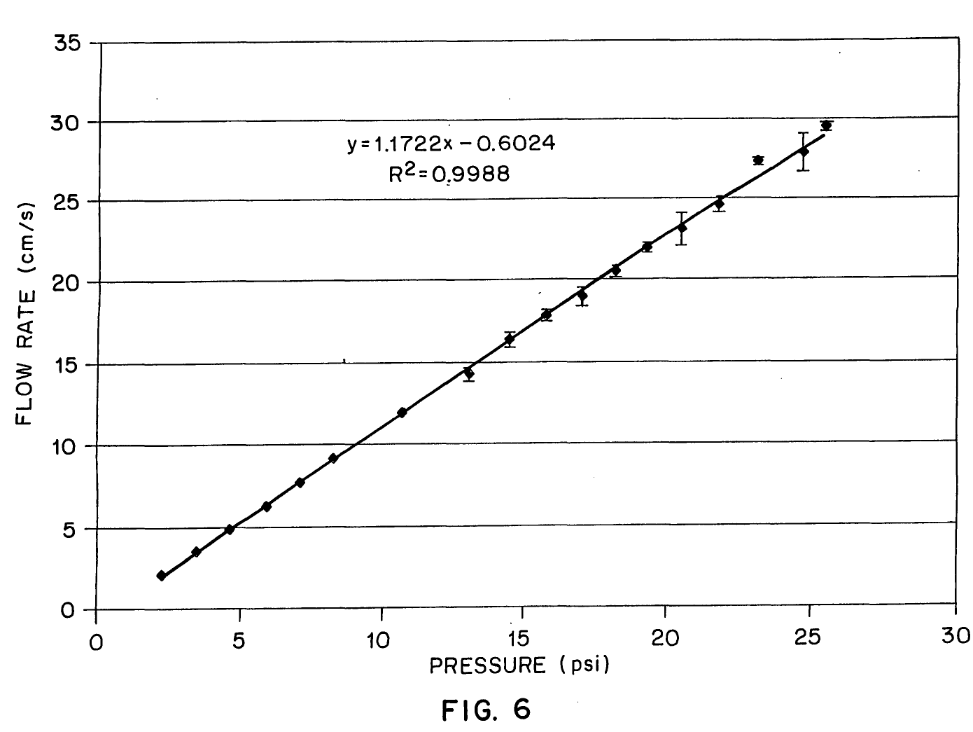

To characterize the flow in the flow monitoring system, various pressures were applied, ranging from about 2 to about 25 psi, and the measured flow rate was plotted for each pressure, as shown in FIG. 6. This data indicates that the system exhibits stability across a range of fluid flow rates and that a linear relationship exists between pressure and flow rates, as expected and described by the Poiseuille equation.

The above description is illustrative and not limiting. Further modifications will be apparent to one of ordinary skill in the art in light of the disclosure and appended claims.

1. A process for monitoring the flow rate of a fluid stream which comprises:
a. heating the stream with a heating member for a time sufficient to induce a change in the refractive index of the fluid;
b. detecting the change in the refractive index of the fluid at a location remote from the heating member; and
c. calculating the flow rate of the fluid from the change in the refractive index.

2. The process of claim 1, wherein the heating member applies pulses of heat to the fluid stream.

3. The process of claim 1, wherein the change in the refractive index of the fluid is detected by laser interference backscatter.

4. Apparatus for monitoring the flow rate of a fluid stream comprising:
a tube having an inlet end and an outlet end;
a heating member disposed outside the tube;
a refractive index detector at a location remote from the heating member; and
a data analyzer connected to the refractive index detector for calculating the flow rate from a change in the refractive index of the fluid stream.

5. The apparatus of claim 4, wherein the capillary or channel tube is held in place with a stabilizing platform on the upstream side and an outlet bracket on the downstream side.

6. The apparatus of claim 5, wherein the heating member is a heating coil embedded into the stabilizing platform and wherein the heating coil attaches to a variable current controller.

7. The apparatus of claim 4, wherein the refractive index detector is a laser interferometric backscatter arrangement.

8. The apparatus of claim 4, wherein the heating member is an infra-red radiation source.

9. The apparatus of claim 4, wherein the heating member is microwave radiation source.

10. The apparatus of claim 4, wherein the refractive index detector comprises two laser interferometric backscatter arrangements connected in series.
